(19) United States
(12) Patent Application Publication
(10) Pub. No.: US 2025/0252970 A1
(43) Pub. Date: Aug. 7, 2025

(54) MAGNETIC HEAD AND MAGNETIC RECORDING DEVICE

(71) Applicant: KABUSHIKI KAISHA TOSHIBA, Tokyo (JP)

(72) Inventors: Akira KIKITSU, Yokohama (JP); Yoshihiro HIGASHI, Komatsu (JP); Satoshi SHIROTORI, Yokohama (JP); Tazumi NAGASAWA, Yokohama (JP)

(21) Appl. No.: 19/016,508

(22) Filed: Jan. 10, 2025

(30) Foreign Application Priority Data
Feb. 1, 2024 (JP) 2024-014247

(51) Int. Cl. G11B 5/11

(52) U.S. Cl. CPC G11B 5/11

(57) ABSTRACT

According to one embodiment, a magnetic head includes a reproducing section including a medium facing face. The reproducing section includes first to fourth shields, a first magnetic member, and first to third terminals. A direction from the first shield to the second shield is along a first direction. A second direction from the third shield to the fourth shield crosses the first direction. The first shield includes a first side including a first end and a first other end. The second shield includes a second side including a second end and a second other end. A distance along a third direction between the first end and the medium facing face is shorter than a distance along the third direction between the first other end and the medium facing face. The third direction crosses the medium facing face.

### CROSS-REFERENCE TO RELATED APPLICATIONS

This application is based upon and claims the benefit of priority from Japanese Patent Application No. 2024-014247, filed on Feb. 1, 2024; the entire contents of which are incorporated herein by reference.

### FIELD

Embodiments described herein relate generally to a magnetic head and a magnetic recording device.

### BACKGROUND

Information recorded on a magnetic recording medium such as an HDD (Hard Disk Drive) is reproduced using a magnetic head that includes a magnetic sensor. Stable characteristics are desired in magnetic heads.

### BRIEF DESCRIPTION OF THE DRAWINGS

FIG. 1 is a schematic view illustrating a magnetic head according to a first embodiment;

FIG. 2 is a schematic view illustrating the magnetic head according to the first embodiment;

FIGS. 3A and 3B are schematic views illustrating the magnetic head according to the first embodiment;

FIGS. 4A and 4B are schematic diagrams illustrating the magnetic head according to the first embodiment;

FIG. 5 is a schematic plan view illustrating a magnetic head according to the first embodiment;

FIG. 6 is a schematic view illustrating a magnetic head according to a second embodiment;

FIG. 7 is a schematic view illustrating the magnetic head according to the second embodiment;

FIG. 8 is a schematic view illustrating a magnetic head according to the second embodiment;

FIG. 9 is a schematic view illustrating the magnetic head according to the second embodiment;

FIG. 10 is a schematic plan view illustrating a part of a magnetic head according to the second embodiment;

FIG. 11 is a schematic plan view illustrating a magnetic head according to a third embodiment;

FIG. 12 is a schematic perspective view illustrating a magnetic head according to the embodiment;

FIG. 13 is a schematic diagram illustrating a magnetic recording device according to an embodiment;

FIG. 14 is a schematic perspective view illustrating the magnetic head according to the embodiment;

FIG. 15 is a schematic perspective view illustrating a part of the magnetic recording device according to the embodiment;

FIG. 16 is a schematic perspective view illustrating the magnetic recording device according to the embodiment; and

FIGS. 17A and 17B are schematic perspective views illustrating a part of the magnetic recording device according to the embodiment.

### DETAILED DESCRIPTION

According to one embodiment, a magnetic head includes a reproducing section including a medium facing face. The reproducing section includes a first shield, a second shield, a third shield, a fourth shield, a first magnetic member, a first terminal, a second terminal, and a third terminal. A direction from the first shield to the second shield is along a first direction. A second direction from the third shield to the fourth shield crosses the first direction. The first magnetic member is provided between the first shield and the second shield, and between the third shield and the fourth shield. The first terminal is electrically connected to the first shield. The second terminal is electrically connected to the second shield. The third terminal is electrically connected to the third shield. The first shield includes a first side including a first end and a first other end. The second shield includes a second side including a second end and a second other end. A distance along a third direction between the first end and the medium facing face is shorter than a distance along the third direction between the first other end and the medium facing face. The third direction crosses the medium facing face. A position of the first end in the second direction is between a position of the third shield in the second direction and a position of the first other end in the second direction. A distance along the third direction between the second end and the medium facing face is shorter than a distance along the third direction between the second other end and the medium facing face. A position of the second end in the second direction is between a position of the second other end in the second direction and a position of the fourth shield in the second direction.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

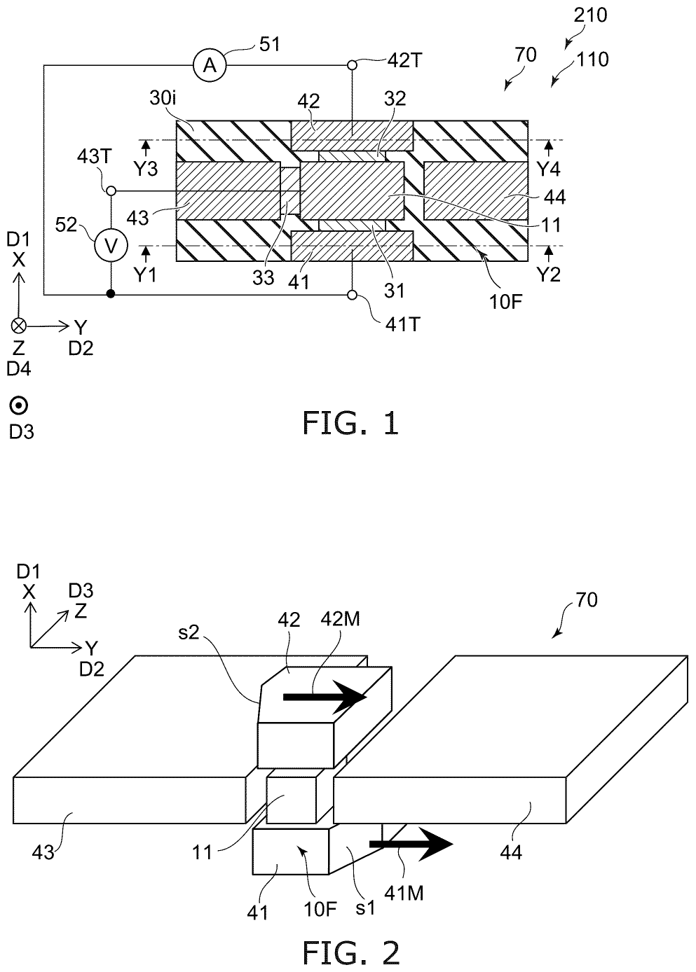

FIGS. 1, 2, 3A, and 3B are schematic views illustrating a magnetic head according to a first embodiment.

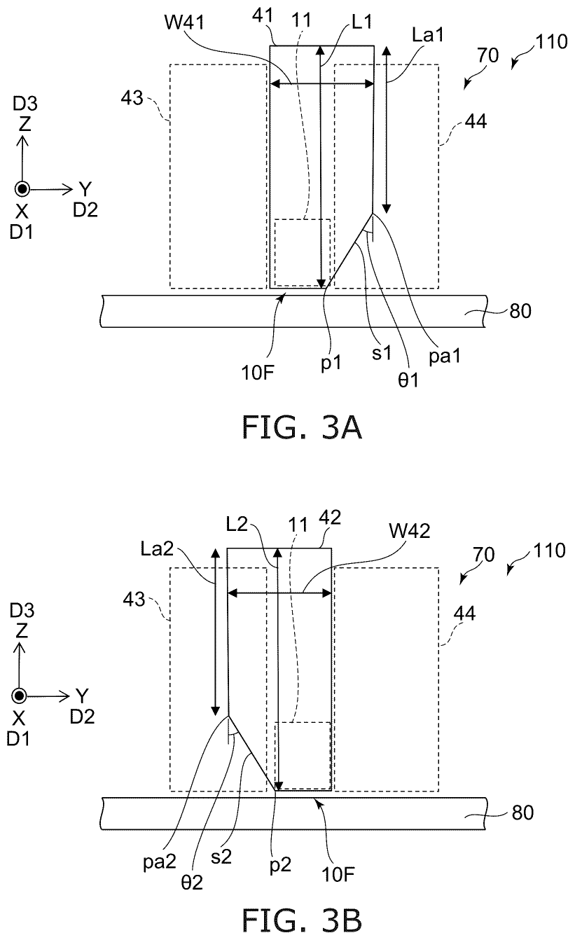

FIG. 1 is a plan view. FIG. 2 is a perspective view of a part of the magnetic head. FIG. 3A is a schematic cross-sectional view taken along the line the Y1-Y2 in FIG. 1. FIG. 3B is a schematic cross-sectional view taken along the line Y3-Y4 in FIG. 1.

As shown in FIG. 1, a magnetic head 110 according to the embodiment includes a reproducing section 70. A magnetic recording device 210 according to the embodiment includes the magnetic head 110 and a magnetic recording medium 80 (see FIGS. 3A and 3B).

As shown in FIGS. 3A and 3B, the reproducing section 70 includes a medium facing face 10F. The medium facing face 10F faces the magnetic recording medium 80. One direction along the medium facing face 10F is defined as an X-axis direction. A direction along the medium facing face 10F and perpendicular to the X-axis direction is defined as a Y-axis direction. A direction perpendicular to the X-axis direction and the Y-axis direction is defined as a Z-axis direction. The medium facing face 10F crosses the Z-axis direction. The medium facing face 10F may be, for example, one face of the first magnetic member 11, which will be described later. FIG. 1 illustrates the reproducing section 70 viewed from the medium facing face 10F.

A direction from the first shield 41 to the second shield 42 is along the first direction D1 along the medium facing face 10F. The first direction D1 is, for example, the X-axis direction.

A second direction D2 from the third shield 43 to the fourth shield 44 is along the medium facing face 10F and crosses the first direction D1. The second direction D2 is, for example, the Y-axis direction.

The first magnetic member 11 is provided between the first shield 41 and the second shield 42, and between the third shield 43 and the fourth shield 44. The first terminal 41T is electrically connected to the first shield 41. The second terminal 42T is electrically connected to the second shield 42. The third terminal 43T is electrically connected to the first magnetic member 11.

The first shield 41 is, for example, one of a trailing shield and a leading shield. The second shield 42 is, for example, the other of the trailing shield and the leading shield. The third shield 43 and the fourth shield 44 are, for example, side shields.

The X-axis direction is, for example, the down-track direction. The Y-axis direction is, for example, a cross-track direction. The Z-axis direction is, for example, the height direction. As shown in FIGS. 2 and 3A, the first shield 41 includes a first side s1. As shown in FIGS. 2 and 3B, the second shield 42 includes a second side s2. The first side s1 and the second side s2 are inclined with respect to the Z-axis direction. The magnetic properties of these shields are controlled by these inclined sides. The first magnetic member 11 is provided between such shields. With such a configuration, a signal corresponding to the information recorded on the magnetic recording medium 80 can be obtained from the reproducing section 70. For example, a voltage (detected signal) between the third terminal 43T and one of the first terminal 41T and the second terminal 42T changes depending on the information recorded on the magnetic recording medium 80.

For example, the magnetization of the first magnetic member 11 depending changes on the information (magnetization) recorded on the magnetic recording medium 80. The detected signal obtained from the reproducing section 70 corresponds to the change in magnetization of the first magnetic member 11. For example, a direction crossing the medium facing face 10F is defined as a third direction D3. The third direction D3 is, for example, the Z-axis direction. For example, a component of the magnetization of the first magnetic member 11 along the third direction D3 changes depending on the information (magnetization) recorded on the magnetic recording medium 80.

On the other hand, for example, a magnetic interaction occurs between the first shield 41 and the first magnetic member 11. For example, an angle between a magnetization of the first magnetic member 11 and a magnetization of a part of the first shield 41 facing the first magnetic member 11 may change depending on the information (magnetization) recorded on the magnetic recording medium 80.

For example, a magnetic interaction occurs between the second shield 42 and the first magnetic member 11. For example, an angle between a magnetization of the first magnetic member 11 and a magnetization of a part of the second shield 42 facing the first magnetic member 11 may change depending on the information (magnetization) recorded on the magnetic recording medium 80. The detected signal obtained from the reproducing section 70 is based on such a change in angle.

In the reproducing section 70 of the reference example, a stacked body including a plurality of magnetic layers is provided between four shields. In this reference example, a plurality of nonmagnetic layers are further provided between the plurality of magnetic layers. The information (magnetization) recorded on the magnetic recording medium 80 is reproduced by the change in the angle between the magnetizations in the two magnetic layers in the stacked body. In the reference example, since a plurality of magnetic layers are necessary, the thickness of each of the plurality of magnetic layers is thin. Therefore, the plurality of magnetic layers has a large thermal fluctuation. Noise is large. It is difficult to obtain stable reproducing operation.

On the other hand, in the embodiment, the first magnetic member 11 (magnetic layer) is provided between the four shields. The thickness of the first magnetic member 11 can be large compared to the reference example. Thereby, the influence of thermal fluctuations is suppressed. It becomes easier to obtain stable reproducing operation. Noise is reduced. According to the embodiment, it is possible to provide a magnetic head that has stable functionalities.

For example, a magnetic interaction between the first shield 41 and the first magnetic member 11 is used for reproduction. Alternatively, a magnetic interaction between the second shield 42 and the first magnetic member 11 is used for reproduction.

As shown in FIG. 3A, the first side s1 of the first shield 41 includes a first end p1 and a first other end pa1. As shown in FIG. 3B, the second side s2 of the second shield 42 includes a second end p2 and a second other end pa2.

As shown in FIG. 3A, a distance along the third direction D3 between the first end p1 and the medium facing face 10F is shorter than a distance along the third direction D3 between the first other end pa1 and the medium facing face 10F. A position of the first end p1 in the second direction D2 is between a position of the third shield 43 in the second direction D2 and a position of the first other end pa1 in the second direction D2. By such a configuration, the first side s1 is inclined with respect to the third direction D3.

As shown in FIG. 3B, a distance along the third direction D3 between the second end p2 and the medium facing face 10F is shorter than a distance along the third direction D3 between the second other end pa2 and the medium facing face 10F. A position of the second end p2 in the second direction D2 is between a position of the second other end pa2 in the second direction D2 and a position of the fourth shield 44 in the second direction D2. By such a configuration, the second side s2 is inclined with respect to the third direction D3. The inclining direction of the second side s2 is opposite to the inclining direction of the first side s1.

With such a configuration, it has been found that the component along the third direction D3 of the magnetization in at least a part of the first shield 41 includes an opposite component to the component along the third direction D3 of the magnetization in at least a part of the second shield 42.

For example, in one example, a first magnetization 41M of the first shield 41 includes a component along the second direction D2. A second magnetization 42M of the second shield 42 includes the component along the second direction D2 described above.

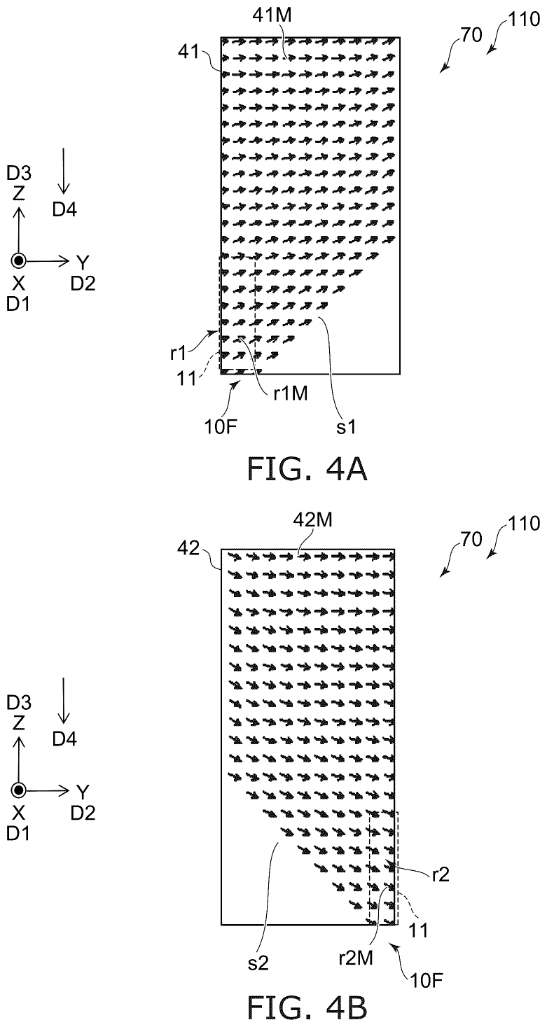

FIGS. 4A and 4B are schematic diagrams illustrating the magnetic head according to the first embodiment.

FIG. 4A illustrates a simulation result of the first magnetization 41M of the first shield 41. FIG. 4B illustrates a simulation result of the second magnetization 42M of the second shield 42. The arrows in these figures represent the direction of magnetization.

As shown in FIG. 4A, the first magnetization 41M of the first shield 41 is along the second direction D2 as a whole. In particular, the first magnetization 41M of the first shield 41 is substantially parallel to the second direction D2 at a position far from the medium facing face 10F. As shown in FIG. 4B, the second magnetization 42M of the second shield 42 is along the second direction D2 as a whole. In particular, the second magnetization 42M of the second shield 42 is substantially parallel to the second direction D2 at a position far from the medium facing face 10F.

As shown in FIG. 4A, in a part of the first shield 41, the magnetization includes a component along the third direction D3. For example, the first shield 41 includes a first region r1. The first region r1 faces the first magnetic member 11. A first region magnetization r1M of the first region r1 includes a component along the third direction D3. As shown in FIG. 4B, the magnetization in a part of the second shield 42 includes a component along the third direction D3. The second shield 42 includes a second region r2. The second region r2 faces the first magnetic member 11. A second region magnetization r2M of the second region r2 includes a component along the fourth direction D4, which is opposite to the third direction D3.

For example, on the inclined first side s1, the magnetization includes a component along the third direction D3. On the inclined second side s2, the magnetization includes a component along the fourth direction D4, which is opposite to the third direction D3. The magnetization on these sides is supposed to influence the magnetization in the first region r1 and the second region r2 includes a component along the third direction D3 or the fourth direction D4.

Due to a change in the angle between the first region magnetization r1M including the component along the third direction D3 and the magnetization of the first magnetic member 11, a first electrical resistance between the first shield 41 and the first magnetic member 11 changes. This is due to the magnetoresistance effect. Due to a change in an angle between the second region magnetization r2M including the component along the fourth direction D4 and the magnetization of the first magnetic member 11, a second electrical resistance between the second shield 42 and the first magnetic member 11 changes. This is due to the magnetoresistance effect.

The component of the first region magnetization r1M along the third direction D3 and the component of the second region magnetization r2M along the third direction D3 are opposite to each other. Therefore, for example, when the direction of magnetization of the first magnetic member 11 changes and the first electrical resistance increases, the second electrical resistance decreases. For example, when the first electrical resistance decreases, the second electrical resistance increases. Therefore, information recorded on the magnetic recording medium 80 can be reproduced with high sensitivity.

As shown in FIG. 3A, an angle between the first side s1 and the third direction D3 is defined as a first angle θ1. In the embodiment, the first angle θ1 may be, for example, not less than 5 degrees and not more than 85 degrees. As shown in FIG. 3B, an angle between the second side s2 and the third direction D3 is defined as a second angle θ2. The second angle θ2 may be, for example, not less than 5 degrees and not more than 85 degrees.

As shown in FIG. 3A, the first shield 41 has a first end length L1 that extends along a straight line passing through the first end p1 and extending in the third direction D3. The first shield 41 has a first other end length La1 that extends along a straight line passing through the first other end pa1 and extending in the third direction D3. The first end length L1 is not less than 1.1 times and not more than 10 times the first other end length La1. As shown in FIG. 3B, the second shield 42 has a second end length L2 that extends along a straight line passing through the second end p2 and extending in the third direction D3. The second shield 42 has a second other end length La2 that extends along a straight line passing through the second other end pa2 and extending in the third direction D3. The second end length L2 is not less than 1.1 times and not more than 10 times the second other end length La2. A highly accurate detected signal can be stably obtained.

For example, the first end length L1 may be not less than 10 nm and not more than 10 μm. For example, the first other end length La1 may be not less than 10 nm and not more than 10 μm. For example, the second end length L2 may be not less than 10 nm and not more than 10 μm. For example, the second other end length La2 may be not less than 10 nm and not more than 10 μm.

As shown in FIG. 3A, a length of the first shield 41 along the second direction D2 is defined as a first shield width W41. In one example, the first shield width W41 is not less than 1 nm and not more than 1 μm. As shown in FIG. 3B, a length of the second shield 42 along the second direction D2 is defined as a second shield width W42. In one example, the second shield width W42 is not less than 1 nm and not more than 1 μm.

As shown in FIG. 1, the reproducing section 70 may further include a first nonmagnetic layer 31 and a second nonmagnetic layer 32. The first nonmagnetic layer 31 is provided between the first shield 41 and the first magnetic member 11. The second nonmagnetic layer 32 is provided between the first magnetic member 11 and the second shield 42.

At least one of the first nonmagnetic layer 31 or the second nonmagnetic layer 32 includes at least one selected from the group consisting of Cu, Al, Au, Ag, W, Ta, Si, AlO, and MgO. When these nonmagnetic layers include a conductive material, the shield and the first magnetic member 11 form a GMR element. When these nonmagnetic layers include an insulating material, the shield and the first magnetic member 11 form a TMR element.

In this example, the reproducing section 70 further includes a third nonmagnetic layer 33. The third nonmagnetic layer 33 is provided between the first magnetic member 11 and the third shield 43. The third nonmagnetic layer 33 is electrically connected to the first magnetic member 11 and the third shield 43. In this case, the third terminal 43T may be electrically connected to the third shield 43. In one example, the third nonmagnetic layer 33 includes at least one selected from the group consisting of Cu, Al, Au, and Ag. For example, a highly sensitive detected signal can be obtained.

As shown in FIG. 1, the magnetic recording device 210 according to the embodiment includes the magnetic head 110 according to the embodiment, and the magnetic recording medium 80 facing the magnetic head 110 (see FIGS. 3A and 3B), a first circuit 51, and a second circuit 52. The first circuit 51 is configured to supply current between the first terminal 41T and the second terminal 42T. The second circuit 52 is configured to detect a potential of the first magnetic member 11. For example, the second circuit 52 is configured to detect a voltage between the third terminal 43T and one of the first terminal 41T and the second terminal 42T. The voltage changes depending on the magnetization state recorded on the magnetic recording medium 80. The voltage corresponds to the detected signal described above. According to the embodiment, it is possible to provide a magnetic recording device that has stable functionalities.

As shown in FIG. 3A, a part of the first shield 41 may overlap the fourth shield 44 in the first direction D1. As shown in FIG. 3B, a part of the second shield 42 may overlap the third shield 43 in the first direction D1. The reproducing section 70 may include an insulating member 30i. At least a part of the insulating member 30i is provided between these shields.

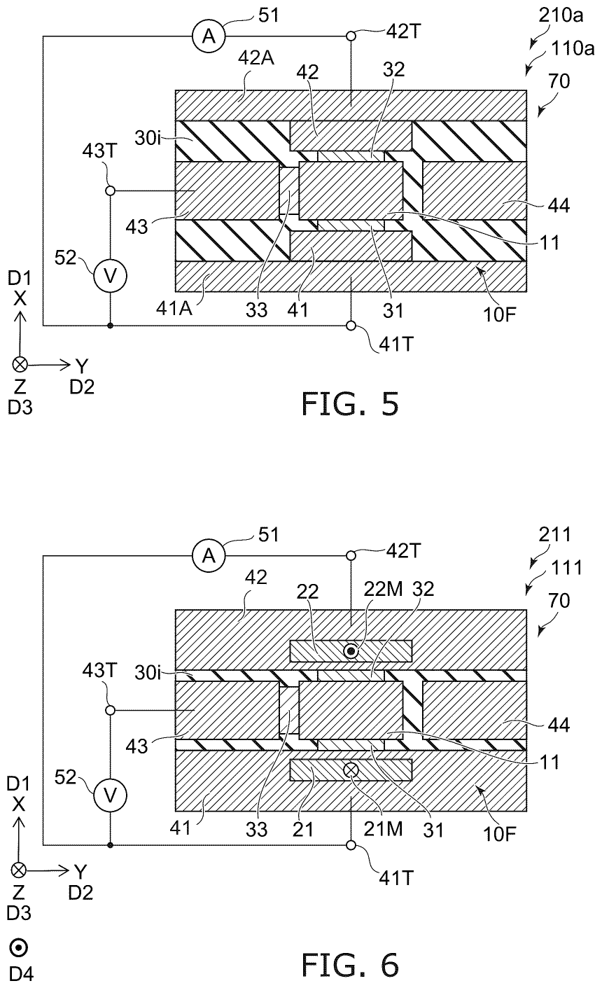

FIG. 5 is a schematic plan view illustrating a magnetic head according to the first embodiment.

FIG. 5 illustrates the reproducing section 70 in a magnetic head 110a according to the embodiment. FIG. 5 illustrates the reproducing section 70 viewed from the medium facing face 10F.

In the magnetic head 110a, the reproducing section 70 further includes a first other shield 41A and a second other shield 42A. The configuration of the magnetic head 110a except for this may be the same as the configuration of the magnetic head 110.

The first shield 41 is provided between the first other shield 41A and the first magnetic member 11 in the first direction D1. The second shield 42 is provided between the first magnetic member 11 and the second other shield 42A in the first direction D1. At least a part of the third shield 43 is provided between the first other shield 41A and the second other shield 42A in the first direction D1. At least a part of the fourth shield 44 is provided between the first other shield 41A and the second other shield 42A in the first direction D1.

In such a magnetic head 110a as well, for example, the influence of thermal fluctuations is suppressed. For example, it becomes easier to obtain stable reproducing operation.

In the embodiment, the first magnetic member 11 includes, for example, at least one selected from the group consisting of Fe and Co. At least one of the first shield 41, the second shield 42, the third shield 43, or the fourth shield 44 includes at least one selected from the group consisting of Fe, Co, and Ni. These shields may include soft magnetic materials.

### Second Embodiment

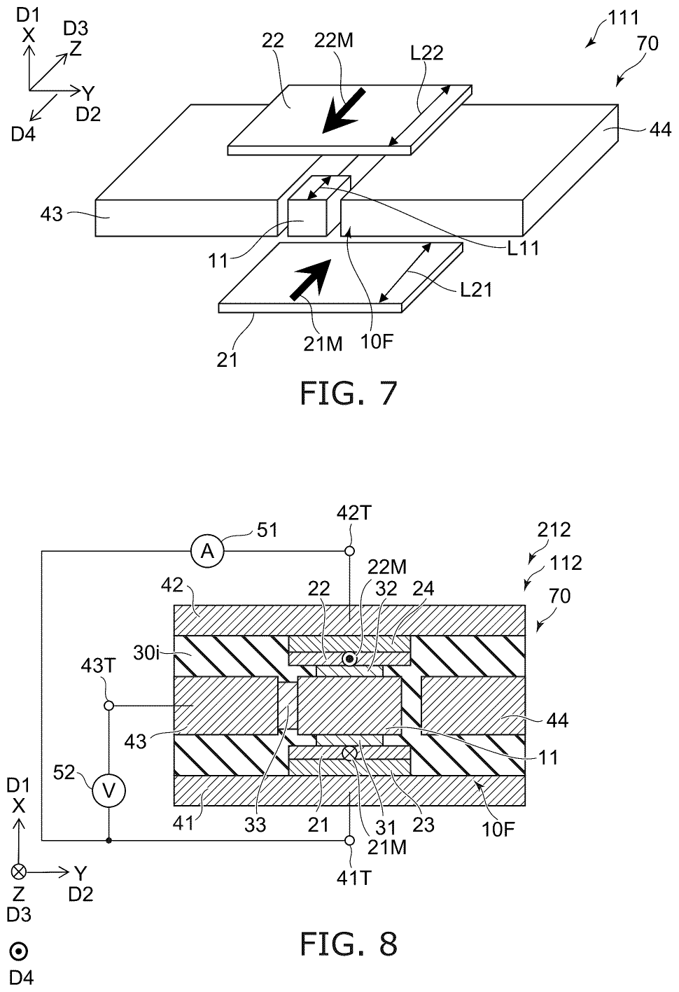

FIGS. 6 and 7 are schematic views illustrating a magnetic head according to the second embodiment.

FIG. 6 is a plan view. FIG. 7 is a perspective view of a part of the magnetic head.

As shown in FIG. 6, a magnetic head 111 according to the embodiment includes the reproducing section 70. The reproducing section 70 includes the medium facing face 10F. FIG. 6 illustrates the reproducing section 70 viewed from the medium facing face 10F.

The reproducing section 70 includes the first shield 41, the second shield 42, the third shield 43, the fourth shield 44, a first magnetic layer 21, a second magnetic layer 22, the first magnetic member 11, the first terminal 41T, the second terminal 42T, and the third terminal 43T. In FIG. 7, the first shield 41 and the second shield 42 are omitted.

The direction from the first shield 41 to the second shield 42 is along the first direction D1 along the medium facing face 10F. The second direction D2 from the third shield 43 to the fourth shield 44 is along the medium facing face 10F and crosses the first direction D1. The first magnetic member 11 is provided between the first shield 41 and the second shield 42, and between the third shield 43 and the fourth shield 44.

The first terminal 41T is electrically connected to the first shield 41. The second terminal 42T is electrically connected to the second shield 42. The third terminal 43T is electrically connected to the first magnetic member 11. In this example, the third terminal 43T is electrically connected to the first magnetic member 11 via the third shield 43.

The first magnetic member 11 is provided between the first magnetic layer 21 and the second magnetic layer 22 in the first direction D1. As shown in FIG. 6, in this example, a part of the first shield 41 is provided between the first magnetic layer 21 and the first magnetic member 11. A part of the second shield 42 is provided between the first magnetic member 11 and the second magnetic layer 22.

As shown in FIG. 7, a first magnetic layer magnetization 21M of the first magnetic layer 21 includes a component along the third direction D3 crossing the medium facing face 10F. A second magnetic layer magnetization 22M of the second magnetic layer 22 includes a component along the fourth direction D4, which is opposite to the third direction D3.

In a magnetic head 111 as well, the signal corresponding to the information recorded on the magnetic recording medium 80 is obtained from the reproducing section 70. For example, the voltage (detected signal) between the third terminal 43T and one of the first terminal 41T and the second terminal 42T changes depending on the information recorded on the magnetic recording medium 80. In the magnetic head 111 as well, the thickness of the first magnetic member 11 can be increased. Thereby, the influence of thermal fluctuations is suppressed. Noise is reduced. It becomes easier to obtain stable reproducing operation. According to the embodiment, it is possible to provide a magnetic head that can obtain stable functionalities.

As shown in FIG. 7, a length of the first magnetic layer 21 along the third direction D3 is defined as a first magnetic layer length L21. A length of the second magnetic layer 22 along the third direction D3 is defined as a second magnetic layer length L22. The length of the first magnetic member 11 along the third direction D3 is defined as a first magnetic member length L11. For example, the first magnetic layer length L21 is longer than the first magnetic member length L11. For example, the second magnetic layer length L22 is longer than the first magnetic member length L11. For example, the first magnetic layer magnetization 21M can be stable and the second magnetic layer magnetization 22M can be stable.

As shown in FIG. 6, in the magnetic head 111, the reproducing section 70 may include the first nonmagnetic layer 31 and the second nonmagnetic layer 32. The first nonmagnetic layer 31 is provided between the first shield 41 and the first magnetic member 11. The second nonmagnetic layer 32 is provided between the first magnetic member 11 and the second shield 42. At least one of the first nonmagnetic layer 31 or the second nonmagnetic layer 32 includes at least one selected from the group consisting of Cu, Al, Au, Ag, W, Ta, Si, AlO, and MgO.

As shown in FIG. 6, in this example, the reproducing section 70 further includes the third nonmagnetic layer 33. The third nonmagnetic layer 33 is provided between the first magnetic member 11 and the third shield 43. The third nonmagnetic layer 33 is electrically connected to the first magnetic member 11 and the third shield 43, for example. The third terminal 43T is electrically connected to the third shield 43. For example, the third nonmagnetic layer 33 includes at least one selected from the group consisting of Cu, Al, Au, and Ag.

The configuration related to the first embodiment may be applied to the magnetic head 111. For example, as shown in FIG. 6, a magnetic recording device 211 according to the embodiment includes the magnetic head 111 according to the embodiment, and the magnetic recording medium 80 facing the magnetic head 111 (FIGS. 3A and 3B), the first circuit 51, and the second circuit 52. The first circuit 51 is configured to supply current between the first terminal 41T and the second terminal 42T. The second circuit 52 is configured to detect the potential of the first magnetic member 11. For example, the second circuit 52 is configured to detect the voltage between the third terminal 43T and one of the first terminal 41T and the second terminal 42T. The voltage changes depending on the magnetization state recorded on the magnetic recording medium 80. According to the embodiment, it is possible to provide a magnetic recording device that can obtain stable functionalities.

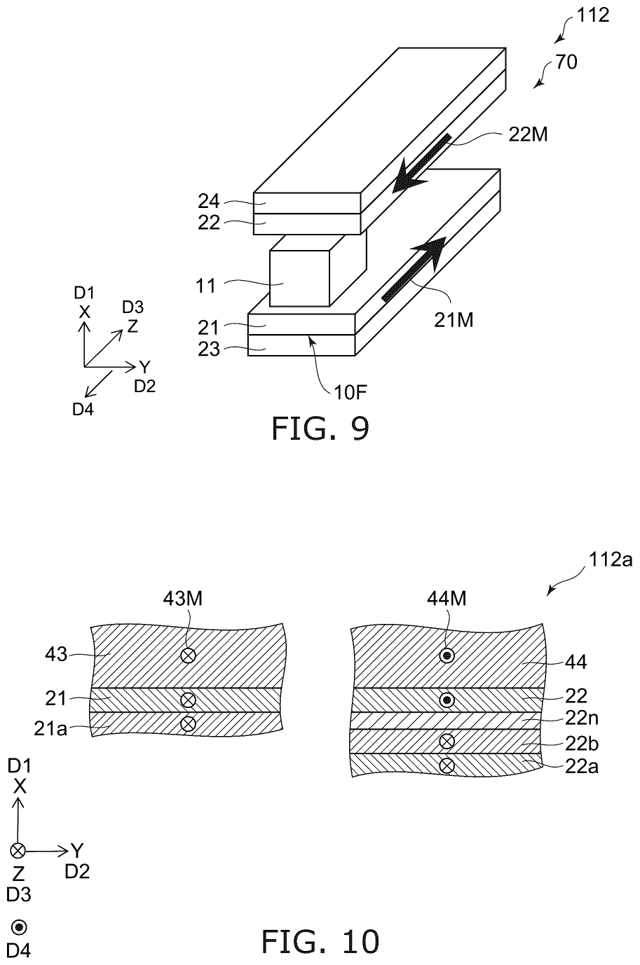

FIGS. 8 and 9 are schematic views illustrating a magnetic head according to the second embodiment.

FIG. 8 is a plan view. FIG. 9 is a perspective view of a part of a magnetic head. FIG. 8 illustrates the reproducing section 70 viewed from the medium facing face 10F.

As shown in FIG. 8, in a magnetic head 112 according to the embodiment, the reproducing section 70 further includes a third magnetic layer 23 and a fourth magnetic layer 24. The configuration of the magnetic head 112 except for this may be the same as the configuration of the magnetic head 111.

The third magnetic layer 23 includes, for example, IrMn. The fourth magnetic layer 24 includes IrMn. The first magnetic layer 21 is provided between the third magnetic layer 23 and the first magnetic member 11. The second magnetic layer 22 is provided between the first magnetic member 11 and the fourth magnetic layer 24. For example, the first magnetic layer magnetization 21M can be stable and the second magnetic layer magnetization 22M can be stable.

The first magnetic layer 21 and the second magnetic layer 22 are, for example, ferromagnetic layers. The third magnetic layer 23 and the fourth magnetic layer 24 are antiferromagnetic layers.

As shown in FIG. 9, the first magnetic layer magnetization 21M of the first magnetic layer 21 includes a component along the third direction D3 crossing the medium facing face 10F. The second magnetic layer magnetization 22M of the second magnetic layer 22 includes a component along the fourth direction D4, which is opposite to the third direction D3.

For example, as shown in FIG. 8, a magnetic recording device 212 according to the embodiment includes the magnetic head 112 according to the embodiment, and the magnetic recording medium 80 facing the magnetic head 112 (FIGS. 3A and 3B), the first circuit 51, and the second circuit 52.

FIG. 10 is a schematic plan view illustrating a part of a magnetic head according to the second embodiment.

As shown in FIG. 10, in a magnetic head 112a according to the embodiment, the reproducing section 70 includes the first magnetic layer 21, a first other magnetic layer 21a, the second magnetic layer 22, a second other magnetic layer 22a, a second opposing magnetic layer 22b and a second intermediate nonmagnetic layer 22n. The configuration of the magnetic head 112a except for this may be the same as the configuration of the magnetic head 112.

For example, the magnetization of the first magnetic layer 21 and the first other magnetic layer 21a includes a component along the third direction D3. The third magnetization 43M of the third shield 43 includes a component along the third direction D3.

For example, the second magnetic layer 22 is provided between the second other magnetic layer 22a and the fourth shield 44. The second magnetic layer 22 is provided between the second opposing magnetic layer 22b and the fourth shield 44. The second opposing magnetic layer 22b is provided between the second other magnetic layer 22a and the fourth shield 44. The second intermediate nonmagnetic layer 22n is provided between the second opposing magnetic layer 22b and the second magnetic layer 22. For example, the second opposing magnetic layer 22b is antiferromagnetically coupled with the second magnetic layer 22.

For example, the magnetization of the second other magnetic layer 22a includes a component along the third direction D3. For example, the magnetization of the second opposing magnetic layer 22b includes a component along the third direction D3. For example, the magnetization of the second magnetic layer 22 includes a component along the fourth direction D4, which is opposite to the third direction D3. For example, the fourth magnetization 44M of the fourth shield 44 includes a component along the fourth direction D4, which is opposite to the third direction D3. By such a configuration, the third shield 43 and the fourth shield 44 can have magnetizations in opposite directions.

For example, the second intermediate nonmagnetic layer 22n includes at least one selected from the group consisting of Cu, Ru, Ir, and Au. Antiferromagnetic coupling is stably and easily obtained. For example, by simple processing, anti-parallel magnetizations can be obtained.

The configuration of the first magnetic layer 21, the first other magnetic layer 21a, the second magnetic layer 22, the second other magnetic layer 22a, the second opposing magnetic layer 22b, and the second intermediate non-magnetic layer 22n described with respect to the magnetic head 112a may be applied to the third magnetic layer 23 and the fourth magnetic layer 24.

### Third Embodiment

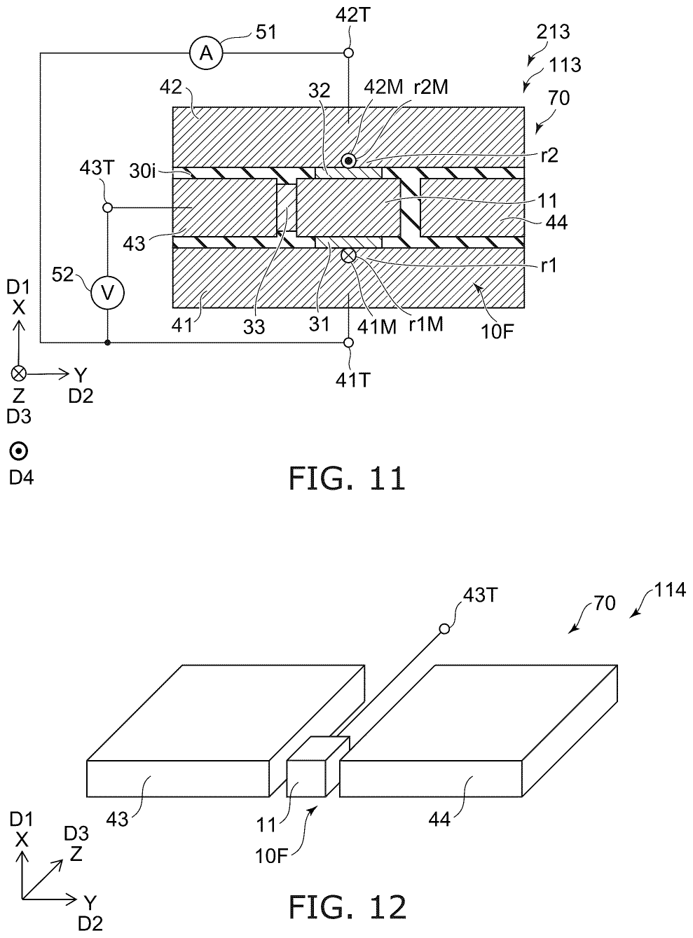

FIG. 11 is a schematic plan view illustrating a magnetic head according to the third embodiment.

As shown in FIG. 11, a magnetic head 113 according to the embodiment includes the reproducing section 70. The reproducing section 70 includes the medium facing face 10F. FIG. 11 illustrates the reproducing section 70 viewed from the medium facing face 10F.

As shown in FIG. 11, in a magnetic head 113, the reproducing section 70 includes the first shield 41, the second shield 42, the third shield 43, the fourth shield 44, the first magnetic member 11, the first terminal 41T, the second terminal 42T, and a third terminal 43T. The direction from the first shield 41 to the second shield 42 is along the first direction D1 along the medium facing face 10F. The second direction D2 from the third shield 43 to the fourth shield 44 is along the medium facing face 10F and crosses the first direction D1.

The first magnetic member 11 is provided between the first shield 41 and the second shield 42, and between the third shield 43 and the fourth shield 44. The first terminal 41T is electrically connected to the first shield 41. The second terminal 42T is electrically connected to the second shield 42. The third terminal 43T is electrically connected to the first magnetic member 11.

In the magnetic head 113, the first magnetization 41M of the first shield 41 includes a component in the third direction D3 crossing the medium facing face 10F. The second magnetization 42M of the second shield 42 includes a component in the fourth direction D4, which is opposite to the third direction D3.

As shown in FIG. 11, for example, the first shield 41 includes the first region r1. The first region r1 faces the first magnetic member 11. The second shield 42 includes the second region r2. The second region r2 faces the first magnetic member 11. The first region magnetization r1M of the first region r1 includes a component along the third direction D3. The second region magnetization r2M of the second region r2 includes a component along the fourth direction D4, which is opposite to the third direction D3.

In such a magnetic head 113 as well, the signal corresponding to the information recorded on the magnetic recording medium 80 is obtained from the reproducing section 70. For example, the voltage (detected signal) between the third terminal 43T and one of the first terminal 41T and the second terminal 42T changes depending on the information recorded on the magnetic recording medium 80. In the magnetic head 113 as well, the thickness of the first magnetic member 11 can be increased. Thereby, the influence of thermal fluctuations is suppressed. Noise is reduced. It becomes easier to obtain stable reproducing operation. According to the embodiment, it is possible to provide a magnetic head that can obtain stable functionalities.

In the magnetic head 113, the reproducing section 70 includes the first nonmagnetic layer 31 and the second nonmagnetic layer 32. The first nonmagnetic layer 31 is provided between the first shield 41 and the first magnetic member 11. The second nonmagnetic layer 32 is provided between the first magnetic member 11 and the second shield 42. At least one of the first nonmagnetic layer 31 or the second nonmagnetic layer 32 includes at least one selected from the group consisting of Cu, Al, Au, Ag, W, Ta, Si, AlO, and MgO.

In this example, the reproducing section 70 further includes the third nonmagnetic layer 33. The third nonmagnetic layer 33 is provided between the first magnetic member 11 and the third shield 43. The third nonmagnetic layer 33 is electrically connected to the first magnetic member 11 and the third shield 43. The third terminal 43T is electrically connected to the third shield 43. The third nonmagnetic layer includes at least one selected from the group consisting of Cu, Al, Au, and Ag.

The configuration related to the first embodiment may be applied to the magnetic head 113. For example, as shown in FIG. 11, a magnetic recording device 213 according to the embodiment includes the magnetic head 112 according to the embodiment, a magnetic recording medium 80 facing the magnetic head 112 (see FIG. 2), and the first circuit 51, the second circuit 52. The first circuit 51 is configured to supply current between the first terminal 41T and the second terminal 42T. The second circuit 52 is configured to detect the potential of the first magnetic member 11. For example, the second circuit 52 is configured to detect the voltage between the third terminal 43T and one of the first terminal 41T and the second terminal 42T. The voltage changes depending on the magnetization state recorded on the magnetic recording medium 80. According to the embodiment, it is possible to provide a magnetic recording device that can obtain stable functionalities.

FIG. 12 is a schematic perspective view illustrating a magnetic head according to the embodiment.

FIG. 12 illustrates the third terminal 43T in a magnetic head 114 according to the embodiment. In the magnetic head 114, the third terminal 43T is connected to the first magnetic member 11 without a shield. The configuration of the magnetic head 114 may be applied to the magnetic heads according to the first to third embodiments.

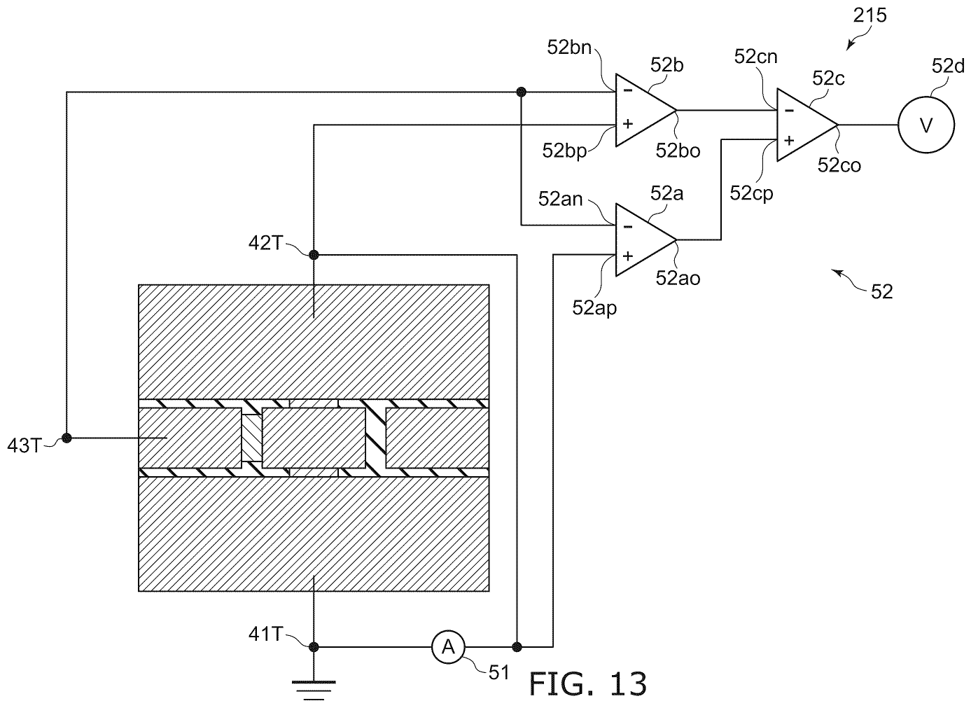

FIG. 13 is a schematic diagram illustrating a magnetic recording device according to an embodiment.

As shown in FIG. 13, the configuration of the second circuit 52 in a magnetic recording device 215 according to the embodiment is illustrated. The second circuit 52 includes a first differential circuit 52a and a second differential circuit 52b. The first differential circuit 52a includes a first input section 52ap and a first other input section 52an. The second differential circuit 52b includes a second input section 52bp and a second other input section 52bn.

For example, the first input section 52ap is a positive input of the first differential circuit 52a. For example, the first other input section 52an is a negative input of the first differential circuit 52a. For example, the second input section 52bp is a positive input of the second differential circuit 52b. For example, the second other input section 52bn is a negative input of the second differential circuit 52b.

The first input section 52ap is electrically connected to the first terminal 41T. The first other input section 52an is electrically connected to the third terminal 43T. The second input section 52bp is electrically connected to the second terminal 42T. The second other input section 52bn is electrically connected to the third terminal 43T.

As shown in FIG. 13, the first differential circuit 52a further includes a first output section 52ao. The second differential circuit 52b further includes a second output section 52bo. At least a part of the signal (reproduced signal) from the reproducing section 70 is obtained from the first differential circuit 52a. At least a part of the signal (reproduced signal) from the reproducing section 70 is obtained from the second differential circuit 52b.

For example, the voltage of the first output section 52ao and the voltage of the second output section 52bo change depending on the information (magnetization) recorded on the magnetic recording medium 80. When the voltage at the first output section 52ao increases, the voltage at the second output section 52bo decreases. When the voltage at the first output section 52ao decreases, the voltage at the second output section 52bo increases.

The second circuit 52 may further include a third differential circuit 52c. The third differential circuit 52c includes a third input section 52cp and a third other input section 52cn. The third input section 52cp is, for example, a positive input of the third differential circuit 52c. The third other input section 52cn is, for example, a negative input of the third differential circuit 52c. The third input section 52cp is electrically connected to one of the first output section 52ao and the second output section 52bo. The third other input section 52cn is electrically connected to another of the first output section 52ao and the second output section 52bo.

For example, the difference between the potential of the first output section 52ao and the potential of the second output section 52bo is output from the third output section 52co of the third differential circuit 52c. By differential processing, for example, higher strength signals are obtained. For example, a signal with suppressed noise can be obtained. Reproduction can be performed with higher accuracy. A signal obtained from the third output section 52co may be supplied to the voltmeter 52d.

The configuration described regarding the magnetic recording device 215 may be applied to any magnetic recording device according to the embodiment.

Hereinafter, an example of the configuration of the magnetic head and the magnetic recording device according to the embodiment will be described. In the following example, the magnetic head 110 is used as the magnetic head according to the embodiment.

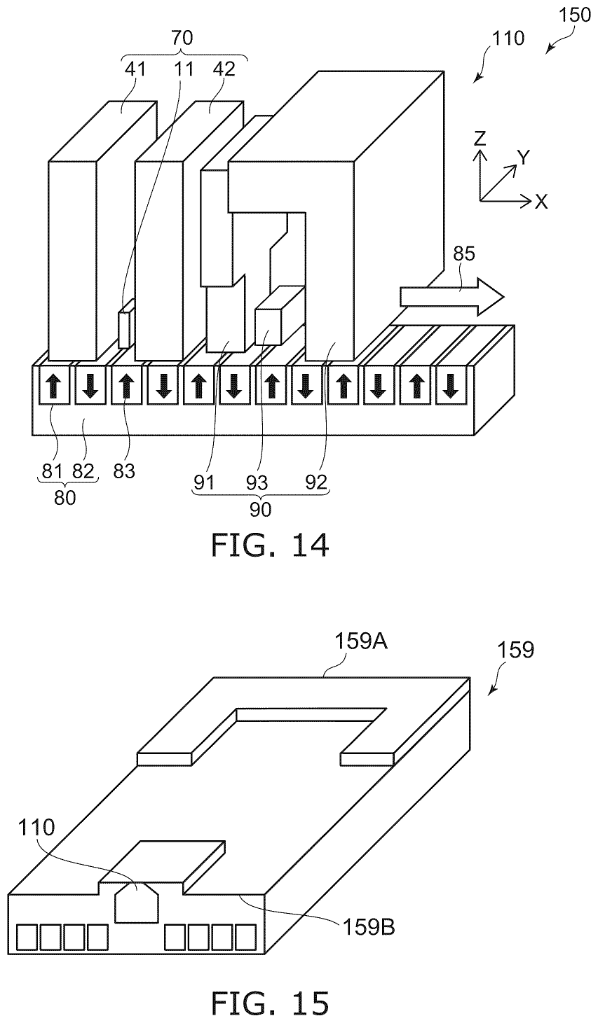

FIG. 14 is a schematic perspective view illustrating the magnetic head according to the embodiment.

As shown in FIG. 14, the magnetic head 110 according to the embodiment may further include a recording section 90. Information is recorded on the magnetic recording medium 80 by the recording section 90 of the magnetic head 110. The reproducing section 70 reproduces information recorded on the magnetic recording medium 80.

The magnetic recording medium 80 includes, for example, a medium substrate 82 and a magnetic recording layer 81 provided on the medium substrate 82. A magnetization 83 of the magnetic recording layer 81 is controlled by the recording section 90. The recording section 90 includes, for example, a first magnetic pole 91 and a second magnetic pole 92. The first magnetic pole 91 is, for example, a main magnetic pole. The second magnetic pole 92 is, for example, a trailing shield. The recording section 90 may include a recording section element 93. The recording section element 93 may include a magnetic field control element, a heating element, a high frequency oscillation element, or the like. The recording section element 93 may be omitted.

The reproducing section 70 includes, for example, the first shield 41, the second shield 42, and the first magnetic member 11. The first magnetic member 11 can output a signal according to the magnetization 83 of the magnetic recording layer 81. In FIG. 14, the third shield 43 and fourth shield 44 are omitted.

As shown in FIG. 14, the magnetic recording medium 80 moves relative to the magnetic head 110 in a medium movement direction 85. The magnetic head 110 controls information corresponding to the magnetization 83 of the magnetic recording layer 81 at an arbitrary position. The magnetic head 110 reproduces information corresponding to the magnetization 83 of the magnetic recording layer 81 at an arbitrary position.

FIG. 15 is a schematic perspective view illustrating a part of the magnetic recording device according to the embodiment.

FIG. 15 illustrates a head slider.

The magnetic head 110 is provided on the head slider 159. The head slider 159 includes, for example, Al₂O₃/TiC or the like. The head slider 159 moves relative to the magnetic recording medium while floating or in contact with the magnetic recording medium.

The head slider 159 includes, for example, an air inflow side 159A and an air outflow side 159B. The magnetic head 110 is arranged on the side surface of the air outflow side 159B of the head slider 159 or the like. As a result, the magnetic head 110 moves relative to the magnetic recording medium while flying above or in contact with the magnetic recording medium.

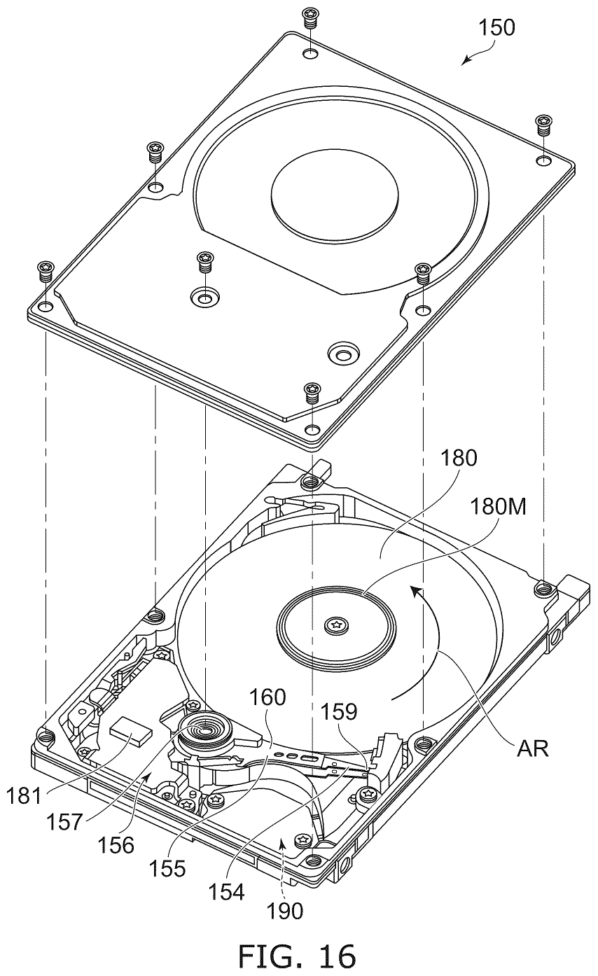

FIG. 16 is a schematic perspective view illustrating the magnetic recording device according to the embodiment.

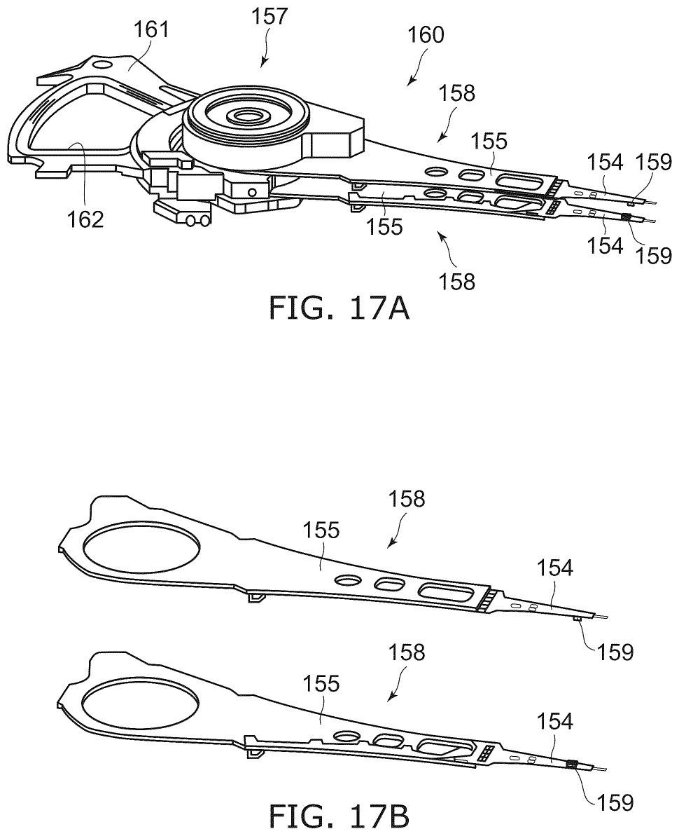

FIGS. 17A and 17B are schematic perspective views illustrating a part of the magnetic recording device according to the embodiment.

As shown in FIG. 16, in a magnetic recording device 150 according to the embodiment, a rotary actuator is used. The recording medium disk 180 is connected to a spindle motor 180M. The recording medium disk 180 is rotated in a direction of arrow AR by the spindle motor 180M. The spindle motor 180M is responsive to control signals from the drive device controller. The magnetic recording device 150 according to the embodiment may include the multiple recording medium disks 180. The magnetic recording device 150 may include a recording medium 181. The recording medium 181 is, for example, an SSD (Solid State Drive). A non-volatile memory such as a flash memory is used for the recording medium 181, for example. For example, the magnetic recording device 150 may be a hybrid HDD (Hard Disk Drive).

The head slider 159 records and reproduces information to be recorded on the recording medium disk 180. The head slider 159 is provided at an end of a thin-film suspension 154. A magnetic head according to the embodiment is provided near the end of the head slider 159.

While the recording medium disk 180 is rotating, the pressing pressure by the suspension 154 and the floating pressure generated at the medium facing face (ABS) of the head slider 159 are balanced. The distance between the medium facing face of the head slider 159 and the surface of the recording medium disk 180 is the predetermined fly height. In the embodiment, the head slider 159 may contact the recording medium disk 180. For example, a contact sliding type may be applied.

The suspension 154 is connected to one end of an arm 155 (e.g., an actuator arm). The arm 155 includes, for example, a bobbin part or the like. The bobbin part holds a drive coil. A voice coil motor 156 is provided at the other end of the arm 155. The voice coil motor 156 is a type of linear motor. The voice coil motor 156 includes, for example, a drive coil and a magnetic circuit. The drive coil is wound on the bobbin part of the arm 155. The magnetic circuit includes permanent magnets and opposing yokes. The drive coil is provided between the permanent magnet and the opposing yoke. The suspension 154 includes one end and the other end. The magnetic head is provided at one end of the suspension 154. The arm 155 is connected to the other end of the suspension 154.

The arm 155 is held by ball bearings. Ball bearings are provided at two locations above and below a bearing part 157. The arm 155 can be rotated and slid by the voice coil motor 156. The magnetic head can move to any position on the recording medium disk 180.

FIG. 17A is an enlarged perspective view of the head stack assembly 160, illustrating the configuration of a part of the magnetic recording device.

FIG. 17B is a perspective view illustrating the magnetic head assembly (head gimbal assembly: HGA) 158 that forms part of the head stack assembly 160.

As shown in FIG. 17A, the head stack assembly 160 includes the bearing part 157, the magnetic head assembly 158 and a support frame 161. The magnetic head assembly 158 extends from the bearing part 157. The support frame 161 extends from the bearing part 157. A direction in which the support frame 161 extends is opposite to a direction in which the magnetic head assembly 158 extends. The support frame 161 supports a coil 162 of the voice coil motor 156.

As shown in FIG. 17B, the magnetic head assembly 158 includes the arm 155 extending from the bearing part 157 and the suspension 154 extending from the arm 155.

The head slider 159 is provided at the end of the suspension 154. The head slider 159 is provided with the magnetic head according to the embodiment.

The magnetic head assembly 158 (head gimbal assembly) according to the embodiment includes the magnetic head according to the embodiment, the head slider 159 provided with the magnetic head, the suspension 154 and the arm 155. The head slider 159 is provided at one end of the suspension 154. The arm 155 is connected to the other end of the suspension 154.

The suspension 154 may include, for example, a wiring (not shown) for recording and reproducing signals. The suspension 154 may include, for example, a heater wiring (not shown) for adjusting the fly height. The suspension 154 may include a wiring (not shown) for, for example, an oscillator element or the like. These wires may be electrically connected to multiple electrodes provided on the magnetic head.

A signal processor 190 is provided in the magnetic recording device 150. The signal processor 190 uses a magnetic head to record and reproduce signals on a magnetic recording medium. Input/output lines of the signal processor 190 are connected to, for example, electrode pads of the magnetic head assembly 158 and electrically connected to the magnetic head.

The magnetic recording device 150 according to the embodiment includes the magnetic recording medium, the magnetic head according to the embodiment, a movable part, a position controller, and a signal processor. The movable part separates the magnetic recording medium from the magnetic head or makes them relatively movable while they are in contact with each other. The position controller aligns the magnetic head with a predetermined recording position on the magnetic recording medium. The signal processor records and reproduces signals on the magnetic recording medium using the magnetic head.

For example, the recording medium disk 180 is used as the above magnetic recording medium. The movable part includes, for example, the head slider 159. The position controller described above includes, for example, the magnetic head assembly 158.

The embodiments may include the following Technical proposals:

### (Technical Proposal 1)

A magnetic head, comprising:
a reproducing section including a medium facing face,
the reproducing section including:
   a first shield;
   a second shield, a direction from the first shield to the second shield being along a first direction;
   a third shield;
   a fourth shield, a second direction from the third shield to the fourth shield crossing the first direction;
   a first magnetic member provided between the first shield and the second shield, and between the third shield and the fourth shield;
   a first terminal electrically connected to the first shield;
   a second terminal electrically connected to the second shield; and
   a third terminal electrically connected to the third shield,
the first shield including a first side including a first end and a first other end,
the second shield including a second side including a second end and a second other end,
a distance along a third direction between the first end and the medium facing face being shorter than a distance along the third direction between the first other end and the medium facing face,
the third direction crossing the medium facing face;
a position of the first end in the second direction being between a position of the third shield in the second direction and a position of the first other end in the second direction,
a distance along the third direction between the second end and the medium facing face being shorter than a distance along the third direction between the second other end and the medium facing face,
a position of the second end in the second direction being between a position of the second other end in the second direction and a position of the fourth shield in the second direction.

### (Technical Proposal 2)

The magnetic head according to Technical proposal 1, wherein
a third magnetization of the third shield includes a component along the second direction, and
a fourth magnetization of the fourth shield includes the component along the second direction.

### (Technical Proposal 3)

The magnetic head according to Technical proposal 1 or 2, wherein
a first angle between the first side and the third direction is not less than 5 degrees and not more than 85 degrees, and
a second angle between the second side and the third direction is not less than 5 degrees and not more than 85 degrees.

### (Technical Proposal 4)

The magnetic head according to any one of Technical proposals 1-3, wherein
a part of the first shield overlaps the fourth shield in the first direction, and
a part of the second shield overlaps the third shield in the first direction.

### (Technical Proposal 5)

The magnetic head according to any one of Technical proposals 1-4, wherein
the reproducing section includes:
a first nonmagnetic layer provided between the first shield and the first magnetic member; and
a second nonmagnetic layer provided between the first magnetic member and the second shield.

### (Technical Proposal 6)

The magnetic head according to Technical proposal 5, wherein
at least one of the first nonmagnetic layer or the second nonmagnetic layer includes at least one selected from the group consisting of Cu, Al, Au, Ag, W, Ta, Si, AlO, and MgO.

### (Technical Proposal 7)

The magnetic head according to any one of Technical proposals 1-6, wherein
the reproducing section further includes a third nonmagnetic layer provided between the first magnetic member and the third shield,
the third nonmagnetic layer is electrically connected to the first magnetic member and the third shield,
the third terminal is electrically connected to the third shield, and
the third nonmagnetic layer includes at least one selected from the group consisting of Cu, Al, Au, and Ag.

### (Technical Proposal 8)

The magnetic head according to any one of Technical proposals 1-7, wherein
the reproducing section further includes a first other shield and a second other shield,
the first shield is provided between the first other shield and the first magnetic member in the first direction,
the second shield is provided between the first magnetic member and the second other shield in the first direction,
at least a part of the third shield is provided between the first other shield and the second other shield in the first direction, and
at least a part of the fourth shield is provided between the first other shield and the second other shield in the first direction.

### (Technical Proposal 9)

The magnetic head according to any one of Technical proposals 1-8, wherein
the first shield includes a first region facing the first magnetic member,
the second shield includes a second region facing the first magnetic member,
a first region magnetization of the first region includes a component along the third direction, and
a second region magnetization of the second region includes a component along a fourth direction opposite to the third direction.

### (Technical Proposal 10)

A magnetic head, comprising:
a reproducing section including a medium facing face,
the reproducing section including:
   a first shield;
   a second shield, a direction from the first shield to the second shield being along a first direction along the medium facing face;
   a third shield;
   a fourth shield, a second direction from the third shield to the fourth shield being along the medium facing face and crossing the first direction;
   a first magnetic member provided between the first shield and the second shield, and between the third shield and the fourth shield;
   a first magnetic layer;
   a second magnetic layer;
   a first terminal electrically connected to the first shield;
   a second terminal electrically connected to the second shield; and
   a third terminal electrically connected to the first magnetic member,
the first magnetic member being provided between the first magnetic layer and the second magnetic layer in the first direction,
a first magnetic layer magnetization of the first magnetic layer including a component along a third direction crossing the medium facing face, and
a second magnetic layer magnetization of the second magnetic layer including a component along a fourth direction opposite to the third direction.

### (Technical Proposal 11)

The magnetic head according to Technical proposal 10, wherein
the reproducing section further includes:
a third magnetic layer including IrMn; and
a fourth magnetic layer including IrMn,
the first magnetic layer is provided between the third magnetic layer and the first magnetic member, and
the second magnetic layer is provided between the first magnetic member and the fourth magnetic layer.

### (Technical Proposal 12)

The magnetic head according to Technical proposal 10 or 11, wherein
a part of the first shield is provided between the first magnetic layer and the first magnetic member, and
a part of the second shield is provided between the first magnetic member and the second magnetic layer.

### (Technical Proposal 13)

The magnetic head according to any one of Technical proposals 10-12, wherein
a first magnetic layer length of the first magnetic layer along the third direction is longer than a first magnetic member length of the first magnetic member along the third direction, and
a second magnetic layer length of the second magnetic layer along the third direction is longer than the first magnetic member length.

### (Technical Proposal 14)

The magnetic head according to any one of Technical proposals 10-13, wherein
the reproducing section further includes:
a first nonmagnetic layer provided between the first shield and the first magnetic member; and
a second nonmagnetic layer provided between the first magnetic member and the second shield, and
at least one of the first nonmagnetic layer or the second nonmagnetic layer includes at least one selected from the group consisting of Cu, Al, Au, Ag, W, Ta, Si, AlO, and MgO.

### (Technical Proposal 15)

The magnetic head according to any one of Technical proposals 10-14, wherein
the reproducing section further includes a third nonmagnetic layer provided between the first magnetic member and the third shield,
the third nonmagnetic layer is electrically connected to the first magnetic member and the third shield,
the third terminal is electrically connected to the third shield, and
the third nonmagnetic layer includes at least one selected from the group consisting of Cu, Al, Au, and Ag.

### (Technical Proposal 16)

A magnetic head, comprising:
a reproducing section including a medium facing face,
the reproducing section including:
   a first shield;
   a second shield, a direction from the first shield to the second shield being along a first direction along the medium facing face;
   a third shield;
   a fourth shield, a second direction from the third shield to the fourth shield being along the medium facing face and crossing the first direction;
   a first magnetic member provided between the first shield and the second shield, and between the third shield and the fourth shield;
   a first terminal electrically connected to the first shield;
   a second terminal electrically connected to the second shield; and
   a third terminal electrically connected to the first magnetic member,
a first magnetization of the first shield including a component in a third direction crossing the medium facing face, and
a second magnetization of the second shield including a component in a fourth direction opposite to the third direction.

### (Technical Proposal 17)

The magnetic head according to Technical proposal 16, wherein
the reproducing section further includes:
a first nonmagnetic layer provided between the first shield and the first magnetic member; and
a second nonmagnetic layer provided between the first magnetic member and the second shield,
at least one of the first nonmagnetic layer or the second nonmagnetic layer includes at least one selected from the group consisting of Cu, Al, Au, Ag, W, Ta, Si, AlO, and MgO,
the reproducing section further includes a third nonmagnetic layer provided between the first magnetic member and the third shield,
the third nonmagnetic layer is electrically connected to the first magnetic member and the third shield,
the third terminal is electrically connected to the third shield, and
the third nonmagnetic layer includes at least one selected from the group consisting of Cu, Al, Au, and Ag.

### (Technical Proposal 18)

A magnetic recording device, comprising:
the magnetic head according to any one of Technical proposals 1-17;
a magnetic recording medium facing the magnetic head;
a first circuit; and
a second circuit,
the first circuit being configured to supply a current between the first terminal and the second terminal,
the second circuit being configured to detect a voltage between the third terminal and one of the first terminal and the second terminal,
the voltage being configured to change depending on a magnetization state recorded on the magnetic recording medium.

### (Technical Proposal 19)

The magnetic recording device according to Technical proposal 18, wherein
the second circuit includes:
a first differential circuit including a first input section and a first other input section; and
a second differential circuit including a second input section and a second other input section,
the first input section is electrically connected to the first terminal,
the first other input section is electrically connected to the third terminal,
the second input section is electrically connected to the second terminal, and
the second other input section is electrically connected to the third terminal.

### (Technical Proposal 20)

The magnetic recording device according to Technical proposal 19, wherein
the first differential circuit further includes a first output section,
the second differential circuit further includes a second output section,
the second circuit further includes a third differential circuit including a third input section and a third other input section,
the third input section is electrically connected to one of the first output section and the second output section, and
the third other input section is electrically connected to another of the first output section and the second output section.

According to the embodiment, a magnetic head and a magnetic recording device that can obtain stable characteristics can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in magnetic heads and magnetic recording devices such as shields, magnetic members, terminals, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all magnetic heads and all magnetic recording devices practicable by an appropriate design modification by one skilled in the art based on the magnetic heads and the magnetic recording devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A magnetic head, comprising:
a reproducing section including a medium facing face,
the reproducing section including:
a first shield;
a second shield, a direction from the first shield to the second shield being along a first direction;
a third shield;
a fourth shield, a second direction from the third shield to the fourth shield crossing the first direction;
a first magnetic member provided between the first shield and the second shield, and between the third shield and the fourth shield;
a first terminal electrically connected to the first shield;
a second terminal electrically connected to the second shield; and
a third terminal electrically connected to the third shield,
the first shield including a first side including a first end and a first other end,
the second shield including a second side including a second end and a second other end,
a distance along a third direction between the first end and the medium facing face being shorter than a distance along the third direction between the first other end and the medium facing face,
the third direction crossing the medium facing face;
a position of the first end in the second direction being between a position of the third shield in the second direction and a position of the first other end in the second direction,
a distance along the third direction between the second end and the medium facing face being shorter than a distance along the third direction between the second other end and the medium facing face,
a position of the second end in the second direction being between a position of the second other end in the second direction and a position of the fourth shield in the second direction.

2. The magnetic head according to claim 1, wherein
a third magnetization of the third shield includes a component along the second direction, and
a fourth magnetization of the fourth shield includes the component along the second direction.

3. The magnetic head according to claim 1, wherein
a first angle between the first side and the third direction is not less than 5 degrees and not more than 85 degrees, and
a second angle between the second side and the third direction is not less than 5 degrees and not more than 85 degrees.

4. The magnetic head according to claim 1, wherein
a part of the first shield overlaps the fourth shield in the first direction, and
a part of the second shield overlaps the third shield in the first direction.

5. The magnetic head according to claim 1, wherein
the reproducing section includes:
a first nonmagnetic layer provided between the first shield and the first magnetic member; and
a second nonmagnetic layer provided between the first magnetic member and the second shield.

6. The magnetic head according to claim 5, wherein
at least one of the first nonmagnetic layer or the second nonmagnetic layer includes at least one selected from the group consisting of Cu, Al, Au, Ag, W, Ta, Si, AlO, and MgO.

7. The magnetic head according to claim 1, wherein
the reproducing section further includes a third nonmagnetic layer provided between the first magnetic member and the third shield,
the third nonmagnetic layer is electrically connected to the first magnetic member and the third shield,
the third terminal is electrically connected to the third shield, and
the third nonmagnetic layer includes at least one selected from the group consisting of Cu, Al, Au, and Ag.

8. The magnetic head according to claim 1, wherein
the reproducing section further includes a first other shield and a second other shield,
the first shield is provided between the first other shield and the first magnetic member in the first direction,
the second shield is provided between the first magnetic member and the second other shield in the first direction,
at least a part of the third shield is provided between the first other shield and the second other shield in the first direction, and
at least a part of the fourth shield is provided between the first other shield and the second other shield in the first direction.

9. The magnetic head according to claim 1, wherein
the first shield includes a first region facing the first magnetic member,
the second shield includes a second region facing the first magnetic member,
a first region magnetization of the first region includes a component along the third direction, and
a second region magnetization of the second region includes a component along a fourth direction opposite to the third direction.

10. A magnetic head, comprising:
a reproducing section including a medium facing face,
the reproducing section including:
a first shield;
a second shield, a direction from the first shield to the second shield being along a first direction along the medium facing face;
a third shield;
a fourth shield, a second direction from the third shield to the fourth shield being along the medium facing face and crossing the first direction;
a first magnetic member provided between the first shield and the second shield, and between the third shield and the fourth shield;
a first magnetic layer;
a second magnetic layer;
a first terminal electrically connected to the first shield;
a second terminal electrically connected to the second shield; and
a third terminal electrically connected to the first magnetic member,
the first magnetic member being provided between the first magnetic layer and the second magnetic layer in the first direction,
a first magnetic layer magnetization of the first magnetic layer including a component along a third direction crossing the medium facing face, and
a second magnetic layer magnetization of the second magnetic layer including a component along a fourth direction opposite to the third direction.

11. The magnetic head according to claim 10, wherein
the reproducing section further includes:
a third magnetic layer including IrMn; and
a fourth magnetic layer including IrMn,
the first magnetic layer is provided between the third magnetic layer and the first magnetic member, and
the second magnetic layer is provided between the first magnetic member and the fourth magnetic layer.

12. The magnetic head according to claim 10, wherein
a part of the first shield is provided between the first magnetic layer and the first magnetic member, and
a part of the second shield is provided between the first magnetic member and the second magnetic layer.

13. The magnetic head according to claim 10, wherein
a first magnetic layer length of the first magnetic layer along the third direction is longer than a first magnetic member length of the first magnetic member along the third direction, and
a second magnetic layer length of the second magnetic layer along the third direction is longer than the first magnetic member length.

14. The magnetic head according to claim 10, wherein
the reproducing section further includes:
a first nonmagnetic layer provided between the first shield and the first magnetic member; and
a second nonmagnetic layer provided between the first magnetic member and the second shield, and
at least one of the first nonmagnetic layer or the second nonmagnetic layer includes at least one selected from the group consisting of Cu, Al, Au, Ag, W, Ta, Si, AlO, and MgO.

15. The magnetic head according to claim 10, wherein
the reproducing section further includes a third nonmagnetic layer provided between the first magnetic member and the third shield,
the third nonmagnetic layer is electrically connected to the first magnetic member and the third shield,
the third terminal is electrically connected to the third shield, and
the third nonmagnetic layer includes at least one selected from the group consisting of Cu, Al, Au, and Ag.

16. A magnetic head, comprising:
a reproducing section including a medium facing face,
the reproducing section including:
a first shield;
a second shield, a direction from the first shield to the second shield being along a first direction along the medium facing face;
a third shield;
a fourth shield, a second direction from the third shield to the fourth shield being along the medium facing face and crossing the first direction;
a first magnetic member provided between the first shield and the second shield, and between the third shield and the fourth shield;
a first terminal electrically connected to the first shield;
a second terminal electrically connected to the second shield; and
a third terminal electrically connected to the first magnetic member,
a first magnetization of the first shield including a component in a third direction crossing the medium facing face, and
a second magnetization of the second shield including a component in a fourth direction opposite to the third direction.

17. The magnetic head according to claim 16, wherein
the reproducing section further includes:
a first nonmagnetic layer provided between the first shield and the first magnetic member; and
a second nonmagnetic layer provided between the first magnetic member and the second shield,
at least one of the first nonmagnetic layer or the second nonmagnetic layer includes at least one selected from the group consisting of Cu, Al, Au, Ag, W, Ta, Si, AlO, and MgO,
the reproducing section further includes a third nonmagnetic layer provided between the first magnetic member and the third shield,
the third nonmagnetic layer is electrically connected to the first magnetic member and the third shield,
the third terminal is electrically connected to the third shield, and
the third nonmagnetic layer includes at least one selected from the group consisting of Cu, Al, Au, and Ag.

18. A magnetic recording device, comprising:
the magnetic head according to claim 1;
a magnetic recording medium facing the magnetic head;
a first circuit; and
a second circuit,
the first circuit being configured to supply a current between the first terminal and the second terminal,
the second circuit being configured to detect a voltage between the third terminal and one of the first terminal and the second terminal,
the voltage being configured to change depending on a magnetization state recorded on the magnetic recording medium.

19. The magnetic recording device according to claim 18, wherein
the second circuit includes:
a first differential circuit including a first input section and a first other input section; and
a second differential circuit including a second input section and a second other input section,
the first input section is electrically connected to the first terminal,
the first other input section is electrically connected to the third terminal,
the second input section is electrically connected to the second terminal, and
the second other input section is electrically connected to the third terminal.

20. The magnetic recording device according to claim 19, wherein
the first differential circuit further includes a first output section,
the second differential circuit further includes a second output section,
the second circuit further includes a third differential circuit including a third input section and a third other input section,
the third input section is electrically connected to one of the first output section and the second output section, and
the third other input section is electrically connected to another of the first output section and the second output section.
